(19) United States
(12) Patent Application Publication
(10) Pub. No.: US 2007/0264608 A1
(43) Pub. Date: Nov. 15, 2007

(54) Periodontal mouth probe

(76) Inventor: James B. Brosnihan, Oakland, NE (US)

Correspondence Address: THOMTE LAW OFFICE, L.L.C., 2120 S. 72ND STREET, SUITE 1111, OMAHA, NE, 68124, US

(21) Appl. No.: 11/343,250

(22) Filed: May 9, 2006

(51) Int. Cl. A61C 1/00

(52) U.S. Cl. 433/29

(57) ABSTRACT

A system and method treats periodontal disease by using intraoral light emission, which kills disease-causing pathogens. One aspect uses a fiber optic periodontal probe that may be positioned closely adjacent gum tissue and between teeth. Another aspect uses fiber optic strands intermixed with bristles that may be used as a toothbrush. The system may be provided with interchangeable tips. A rechargeable power source may power the light within the system as well as an agitator that may be coupled with the tips.

### CROSS-REFERENCE TO RELATED APPLICATION

This is a continuation-in-part application of Petitioner's earlier application Ser. No. 11/255,137 filed Oct. 21, 2005, entitled PERIODONTAL MOUTH PIECE.

### BACKGROUND

Recent breakthroughs have proven effective in treating periodontal disease with light, especially blue light (spectrum wavelength 380-520 nanometers). This research was done primarily by the Forsyth Institute in Boston, Mass. Their research was performed both “in vitro” and on human patients with chronic periodontitis using a Brite Smile BS 300 Halogen gas plasma lamp which is an extraoral light lamp originally intended for dental office bleaching. Improvement has been noticed in patients' periodontal status who had been receiving light activated bleachings which led to this research. Light irradiation therapy has been shown to be effective in treating acne recently and lasers have shown some benefit in treating periodontal disease.

However, current treatments that use light as an active component of the therapy have incidentally shown that light kills certain pathogens known to exist in the human mouth. Light penetration into the patient's gum tissue is variable during such treatments due to the fact that the treatments are extraoral in nature. Accordingly, the light that illuminates the gum tissue during a bleaching treatment, for example, will change from blue to pink in the sulcus, due to the fact that the light source doesn't directly illuminate into the sulcus. Therefore, the killing of pathogens during such treatments is not only a secondary effect but the killing is frequently ineffective due to the fact that substantial pathogen populations are not exposed to the light directly and survive the treatment.

Accordingly, what is needed is a novel system and method of using the same that treats gum diseases by systematically killing disease-causing pathogens with light. The system should be easily adaptable to provide various methods of treatment according to the needs of each user. More importantly, the system and method should be provided in a manner that can be easily self-administered.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A system and method for treating periodontal disease with light is provided with a periodontal device having an elongated body, having first and second end portions. The first end portion is shaped and sized to be manually grasped by a user for manipulation of the device. A light source and power source are associated with the body. A system is provided for transmitting the light emitted from the light source along a pathway from the second end portion of the body to user-selected areas of the user's mouth.

The second end portion of the body is provided with one of various designs of tips for assisting in the transmission of the light. One embodiment provides the tip in the form of a periodontal illuminating brush, having a plurality of bristles and a plurality of fiber optic strands, which may be used much like a user's toothbrush. Another embodiment provides the tip in the form of a periodontal illuminating probe, which is comprised of fiber optic material and may be used much in the same manner as a standard periodontal probe. The various embodiments may be provided in the form of removable attachments that may be interchanged with one another.

It is therefore a principal object of the present invention to provide a system and method for effectively treating periodontal diseases using intraoral light emitting techniques.

A further object of the present invention is to provide a system for treating periodontal diseases that emits light intraorally to kill disease-causing pathogens.

Still another object of the present invention is to provide a system for treating periodontal diseases that emits light intraorally through a fiber optic probe to kill disease-causing pathogens.

Another object of the present invention is to provide a system for treating periodontal diseases that emits light intraorally through fiber optic strands inter-mixed with brushing bristles to kill disease-causing pathogens.

A further object of the present invention is to provide a system for treating periodontal diseases that emits light intraorally through one of a plurality of interchangeable attachments to kill disease-causing pathogens.

Still another object of the present invention is to provide a system for treating periodontal diseases that emits light intraorally and may be easily self-administered.

Another object of the present invention is to provide a system for treating periodontal diseases that uses a rechargeable power source to power a light-emitting device, which kills disease-causing pathogens.

A further object of the present invention is to provide a system for treating periodontal diseases that emits light within an approximate wavelength of 380-520 nanometers, intraorally, to kill disease-causing pathogens.

Still another object of the present invention is to provide a system for treating periodontal diseases that emits light intraorally through at least one removable fiber optic probe to kill disease-causing pathogens.

These and other objects of the present invention will be apparent after consideration of the Detailed Description and Figures herein.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a perspective view of one embodiment of the system for treating periodontal tissue disease;

FIG. 2 depicts a partial, cut-away view of the system depicted in FIG. 1 and one embodiment of a removable probe tip that may be used with the same

FIG. 3 depicts an isometric view of an alternate tip that may be used with the system for treating periodontal tissue disease;

FIG. 4 depicts a partial, cut-away, side elevation view of the tip depicted in FIG. 3; and

FIG. 5 depicts a perspective view of one embodiment of the system for treating periodontal tissue, with optional, removable attachments and tips.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The system 10 for treating periodontal tissue disease is provided with a body 12 having a first end portion 14 and an opposite second end portion 16. The first end portion 14 of the body 12 is preferably shaped and sized to be manually grasped by a user for manipulation of the device. A light means 18 is associated with the body 12 for selectively emitting light. It is contemplated that various light emitting structures will suffice for providing the light emitting means 18. It is contemplated, however that preferred structures may include one or more LEDs, plasma, halogen or conventional incandescent light sources. The specific structure used for the light emitting means 18 may depend upon the intended use and the type of treatment being provided. For example, the blue lights, particularly having a spectrum wavelength of 380-520 nanometers, have been found to be particularly adept at killing bacterial pathogens responsible for a wide variety of periodontal tissue diseases.

Irrespective of the light emitting means 18 selected for use within the system 10, a power means must be electrically coupled with the light emitting means 18. The power means may be provided simply in the form of a transformer 20 and power cord 22 that relay electrical current from an electrical outlet to the system 10. However, one or more disposable or rechargeable batteries 24 may also be used as the power source. Where a battery 24 is used, the transformer 20 and power cord 22 may be provided to removably engage the system 10, in a manner common to the electrical arts.

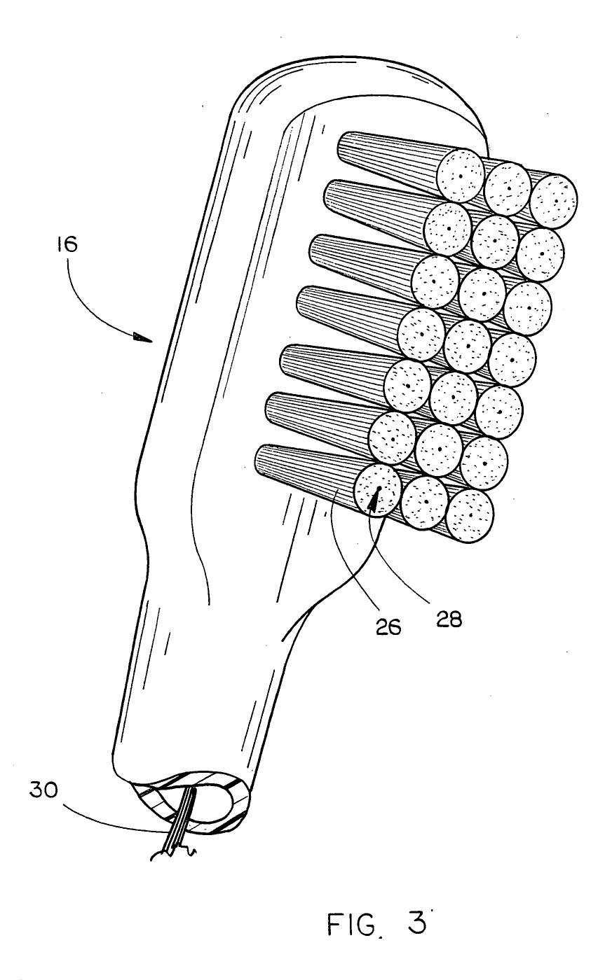

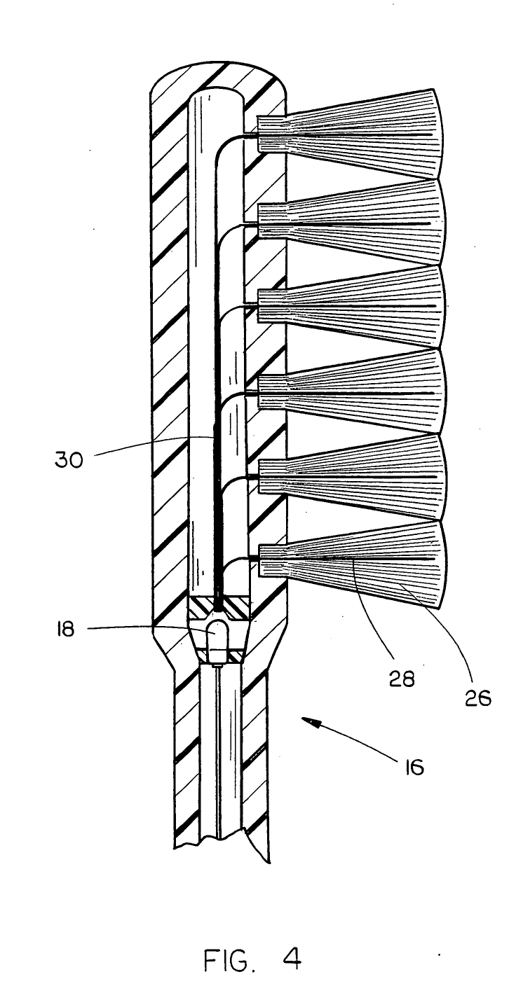

A light transmission means should be provided for directing light emitted from the light emitting means 18 along a pathway from the body 12 to any user-selected areas within the user's mouth. The light transmission means may be provided in the form of one of various forms of tips that are operatively, optically coupled with the light emitting means 18. In one aspect, the tip member may be comprised of a plurality of elongated bristles 26, which are formed to have a deformably resilient nature that enables the bristles 26 to be used in a manner similar to brushing teeth and gum areas within the users mouth. A plurality of elongated, deformably resilient fiber optic strands 28 are intermixed with the bristles 26, as depicted in FIGS. 3 and 4. It is contemplated that the bristles 26 may be formed from various polymers, known in the dental industry for constructing toothbrushes. However, it is further contemplated that the bristles 26 could be comprised of a generally fiber-optic material to receive and direct light from the fiber optic strands 28. In another aspect, the bristles 26 and fiber optic strands 28 may be provided as several groups of fiber optic strands that may not necessarily be intended for use as a toothbrush, but only to be placed at an angle with respect to the long axis of the user's teeth to direct the light deep into periodontal pockets and illuminate the diseased tissue. One or more light emitting means 18 may be positioned closely adjacent the anterior ends of the fiber optic strands 28. However, the light emitting means 18 may be placed remotely from the fiber optic strands 28 and optically coupled thereto by one or more lengths of fiber optic cable 30, as depicted in FIG. 4.

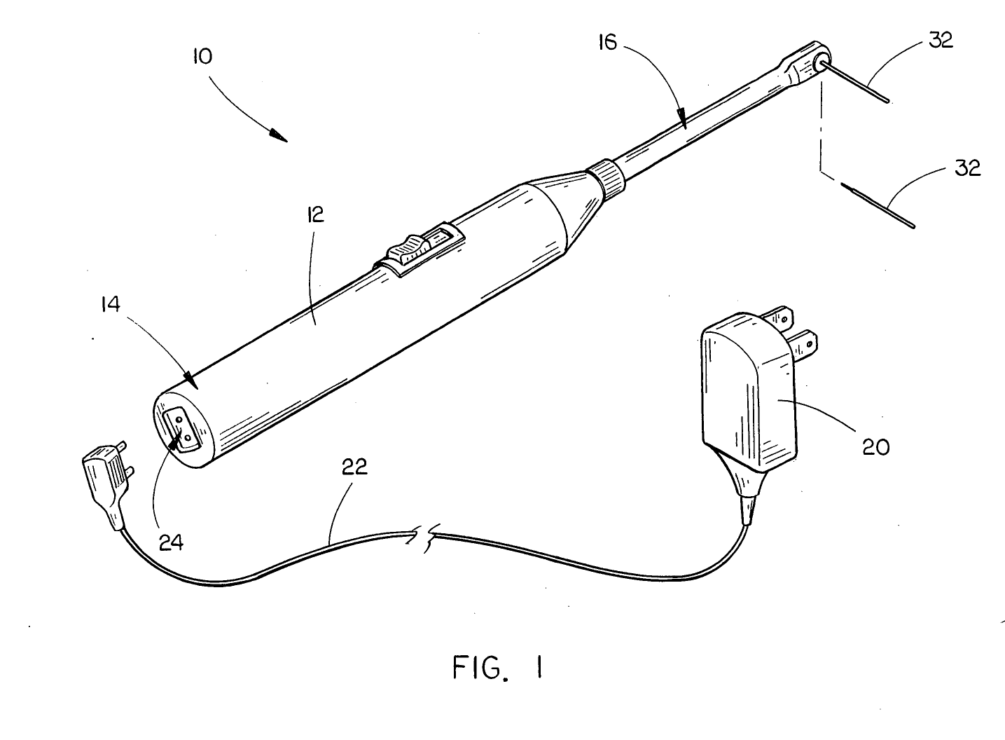

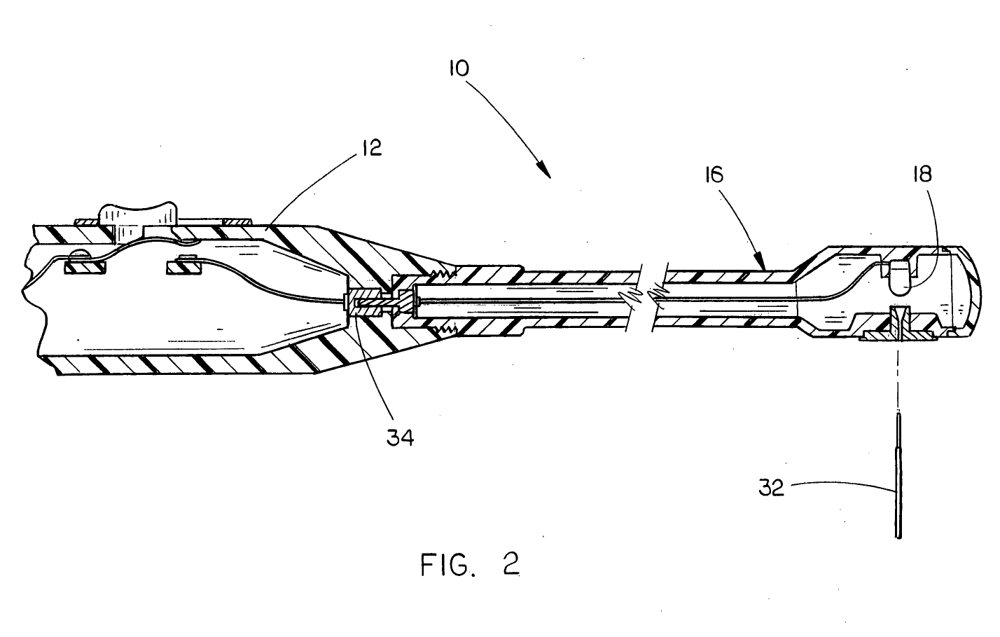

In another embodiment, the tip of the light transmission means may be comprised of at least one elongated probe 32, such as depicted in FIGS. 1 and 2. Preferably, the probes 32 will be comprised of a deformably resilient, fiber optic material that is shaped and sized to be at least partially disposed between a user's teeth. In this manner, the probe 32 may be used to penetrate deep within an infected area, such as an abscess, to illuminate and kill offending pathogens. The probe 32 should be optically coupled with the light emitting means 18 much in one of the manners described previously with respect to the fiber optic strands 28. In one embodiment, the probes 32 may be removably coupled with the second end portion 16 of the body 12 to enable selective replacement of the probe 32, as depicted in FIGS. 1 and 2. In this manner, the system 10 is more readily useable by a plurality of different users and will extend the life of the system 10 by making the individual probes 32 disposable.

In order to further diversify the system 10, it is contemplated that the second end portion 16 of the body 12 may be removably attached thereto. Accordingly, as depicted in FIG. 5, the system 10 may be provided with a plurality of different second end portions 16, having various light transmission tips, for use by different individuals. Where the second end portion 16 of the body 12 is removable, it is contemplated that the light emitting means 18 could be provided within each of the individual second end portions 16 or, economically, disposed within the body 12, anterior of the second end portion 16. In this manner, an elongated fiber optic cord 30 would be provided to extend from the light emitting means 18 to the tip provided at the distal end of the second end portion 16.

Irrespective of the manner in which the second end portion 16 is coupled with the body 12 it may be desirable to provide an agitation means, such as an electrically powered vibration motor 34 for selectively agitating the tip member of the light transmission means 18. It is contemplated that the vibration motor 34 could be operatively coupled with the second end portion 16 in various known methods previously disclosed within the electric toothbrush arts. As with the light emitting means 18, when the second end portion 16 is removably coupled with the body 12, the vibration motor 34 may economically be disposed within the body 12 and mechanically associated with the second end portion 16. However, it is contemplated that a vibration motor 34 may be provided within the second end portion 16, where desirable.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

What is claimed is:

1. A periodontal device for killing pathogens associated with gum diseases, the device comprising:
a body having first and second end portions, the first end portion being shaped and sized to be manually grasped by a user for manipulation of the device;
light means, associated with said body, for selectively emitting light;
a power source electrically coupled with said light emitting means; and
light transmission means for directing light emitted from said light emitting means along a pathway from said body to user-selected areas of the user's mouth.

2. The device of claim 1 wherein said light emitting means is comprised of an LED.

3. The device of claim 1 wherein said light emitting means is comprised of a halogen bulb.

4. The device of claim 1 wherein said light emitting means is provided to emit light within an approximate wavelength of 380-520 nanometers.

5. The device of claim 1 wherein said light transmission means is comprised of a tip member, which is comprised of a fiber optic material.

6. The device of claim 5 wherein said light transmission means is comprised of a length of fiber optic cable that extends from said light emitting means to said tip member.

7. The device of claim 5 further comprising agitation means electrically coupled with said power source for selectively agitating said tip member.

8. The device of claim 5 wherein said tip member is comprised of a plurality of elongated bristles, which are formed to have a deformably resilient nature that enables said bristles to be used by a user for brushing teeth and gum areas within the user's mouth, and a plurality of elongated deformably resilient fiber optic strands that are intermixed with said plurality of bristles.

9. The device of claim 5 wherein said tip member is comprised of at least one elongated probe comprised of a deformably resilient, fiber optic material that is shaped and sized to be used between a user's teeth.

10. The device of claim 9 wherein said at least one probe is removably coupled with the second end portion of said body to enable selective replacement of said at least one probe.

11. The device of claim 5 wherein the second end portion of said body is removably coupled with said body to enable selective replacement or exchange of various different second end portions.

12. The device of claim 11 wherein one second end portion of said body is provided with a tip member that is comprised of a plurality of elongated bristles, which are formed to have a deformably resilient nature that enables said bristles to be used by a user for brushing teeth and gum areas within the user's mouth, and a plurality of elongated deformably resilient fiber optic strands that are intermixed with said plurality of bristles.

13. The device of claim 12 wherein another second end portion of said body is provided with a tip member that is comprised of at least one elongated probe, which is comprised of a deformably resilient, fiber optic material that is shaped and sized to be used between a user's teeth.

14. The device of claim 13 wherein said light emitting means is provided to emit light within an approximate wavelength of 380-520 nanometers.

15. The device of claim 13 wherein said power source is comprised of a rechargeable battery.

16. A method of using the device of claim 5, comprising the steps of:
a) inserting the second end portion of said body into the user's mouth;
b) actuating said light emitting means;
c) manipulating said body to position said tip closely adjacent gum tissue within the user's mouth, such that light is transmitted onto the gum tissue until at least a portion of pathogens associated with gum diseases within the user's mouth are killed.

17. The method of claim 16 wherein said body is manipulated in a manner that disposes at least a portion of said tip between teeth within the user's mouth.

18. The method of claim 16 wherein said body is manipulated in a manner that disposes at least a portion of said tip closely adjacent gum tissue within the user's mouth in a brushing fashion.
